(19) United States
(12) Patent Application Publication
(10) Pub. No.: US 2005/0211396 A1
(43) Pub. Date: Sep. 29, 2005

(54) Protective covering for structures

(76) Inventors: Gerald J. Doiron, Naples, FL (US); James M. McDonough, East Greenwich, RI (US)

Correspondence Address: Michael L. Leetzow;Michael L. Leetzow, P.A., 5123 Shoreline Circle, Sanford, FL, 32771, US

(21) Appl. No.: 10/993,789

(22) Filed: Nov. 20, 2004

Related U.S. Application Data
(60) Provisional application No. 60/556,986, filed on Mar. 29, 2004.

(51) Int. Cl. E06B 9/00

(52) U.S. Cl. 160/222

(57) ABSTRACT

A protective covering for an opening in a structure is presented that allows a single user to install and secure the covering. The protective covering may be easily and quickly installed without many tools or additional parts. The protective covering may also be installed from the inside or the outside, providing a more secure covering that may also be used while the owners of the structure are away for extended periods of time to prevent unauthorized entry.

The present invention relates to a protective covering for a structure, and more particularly, a protective covering for a structure that can be easily installed from the inside or the outside of the structure to which it is attached and which may also be adjustable.

There are several prior art protective coverings or hurricane shutters, however, the majority of those protective coverings have many panels that need to be individually installed and secured or require more than one person to install. These coverings take a long time and require a lot of effort to mount on the structures. Therefore, once these are installed, they are usually left mounted for extended periods of time, making the structure extremely dark and uninviting. There are other protective coverings that require reinforcement members or complicated elements or brackets to attach the shutters or protective device to the structures. Again, these take a long time to install and are usually left in place once installed.

Accordingly, the present invention is directed to a protective covering and method for installing a protective covering on a structure that substantially obviates one or more of the problems and disadvantages in the prior art. Additional features and advantages of the invention will be set forth in the description that follows, and in part will be apparent from the description, or may be learned by practice of the invention. The objectives and other advantages of the invention will be realized and attained by the apparatus and process particularly pointed out in the written description and claims, as well as the appended drawings.

### SUMMARY OF THE INVENTION

To achieve these and other advantages and in accordance with the purpose of the invention as embodied and broadly described herein, the invention is directed to removable, adjustable protective covering for protecting an opening in a structure that includes a first panel, the first panel having an upper edge configured to be attached to a portion of the structure adjacent one side of the opening, and a second panel, the second panel configured to be secured to the first panel and having a lower edge configured to be attached to a portion of the structure adjacent an opposite side of the opening.

In yet another aspect, the invention is directed to an adjustable protective covering for protecting an opening in a structure that includes a first panel for covering at least a portion of the opening in the structure and a second panel for covering at least a portion of the opening and configured to be adjustably secured to the first panel, wherein the first and second panels secured to one another having a size that covers at least a portion of the opening in the structure.

In another aspect, the invention is directed to a removable, adjustable protective covering assembly for protecting an opening in a structure that includes a first panel, the first panel having an upper edge configured to be attached to a portion of the structure adjacent one side of the opening, a plurality of central panels, each of the central panels having a top edge configured to engage a previous panel and a bottom edge configured to engage a next panel, and a final panel, the final panel configured to be secured to one of the plurality of central panels and having a lower edge configured to be attached to a portion of the structure adjacent an opposite side of the opening; wherein the securing of the final panel to the structure locks the panels to protect the opening in the structure.

In another aspect, the invention provides a removable protective covering for protecting an opening in a structure that includes a protective panel sized to cover at least a portion of the opening, the protective panel having an edge configured to be attached to a portion of the structure adjacent a first side of the opening, and a securing means mounted to at least a second side of the opening to secure the protective panel over the at least a portion of the opening.

In yet another aspect, the invention provides for a method of installing a protective covering for protecting an opening in a structure that includes providing a first panel for covering at least a portion of an opening in the structure and a second panel for covering at least a portion of the opening and configured to be adjustably secured to the first panel, the first and second portions covering a majority of the opening, attaching the first panel to a first side of the opening from inside the structure, attaching the second panel to a second side of the opening from inside the structure, and securing the first panel to the second panel from inside the structure with mechanical fasteners such that the fasteners are not easily removable from outside the structure.

It is to be understood that the foregoing general description and the following detailed description are exemplary and explanatory and are intended to provide further explanation of the invention as claimed.

The accompanying drawings are included to provide a further understanding of the invention and are incorporated in and constitute a part of the specification. The drawings illustrate several embodiments of the invention and together with the description serve to explain the principles of the invention.

### BRIEF DESCRIPTION OF THE DRAWINGS

FIG. 1 is a front view of one embodiment of a protective covering mounted on a structure according to the present invention;

FIG. 2 is a side view of the protective covering in FIG. 1 prior to being attached to the structure;

FIG. 3 is a side view of the protective covering in FIG. 1 attached to the structure over an opening;

FIG. 4 is an attachment member used in conjunction with the protective covering of FIG. 1 and mounted to the structure;

FIG. 5 is a side view of another embodiment of a protective covering according to the present invention;

FIG. 6 is a front view of another embodiment of a protective covering according to the present invention;

FIG. 7 is a side view of the protective covering of FIG. 6;

FIG. 8 is a partial view of another embodiment of a protective covering according to the present invention;

FIG. 9 is a partial view of the protective covering of FIG. 8 with the securing hardware reversed for interior mounting;

FIG. 10 is a side view of another embodiment of a protective covering according to the present invention;

FIG. 11 is a front view of another embodiment of a protective covering according to the present invention;

FIG. 12 is a cross sectional view of the protective covering of FIG. 11 along the line 12-12; and

FIG. 13 is a side view of another embodiment of a protective covering according to the present invention.

### DETAILED DESCRIPTION OF THE INVENTION

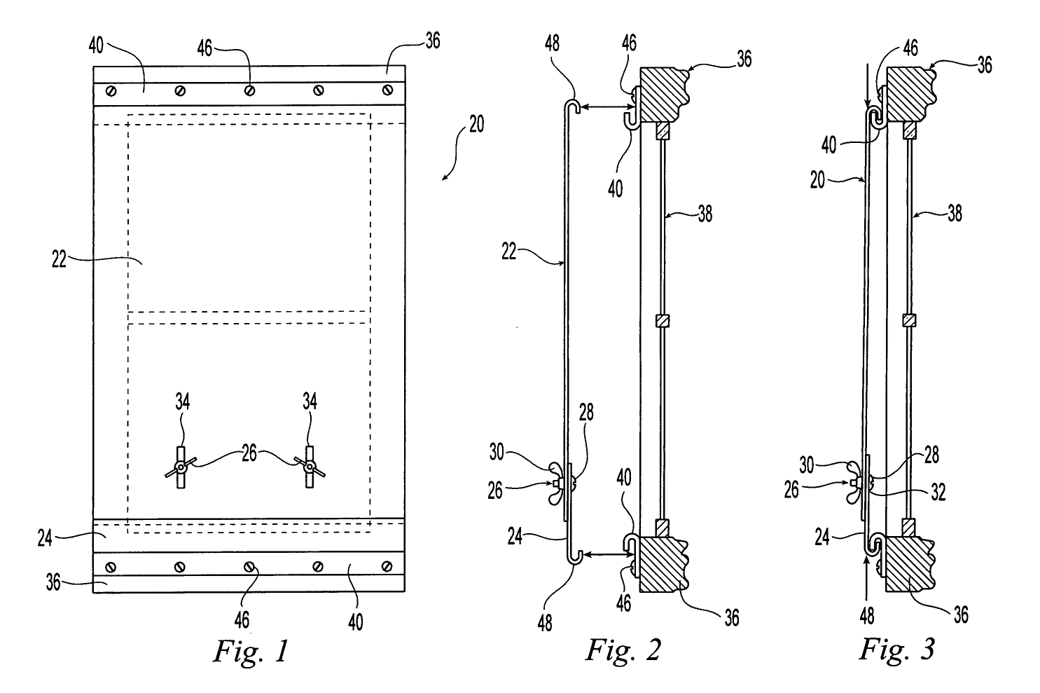

A protective covering 20 according to one embodiment of the present invention is illustrated in FIG. 1. The protective covering 20 has preferably two panels an first panel 22 and a second panel 24. The first and second panels 22,24 are secured to one another by mechanical fasteners 26. The mechanical fasteners 26 are preferably a bolt or machine screw 28 and a wing nut 30. The mechanical fasteners 26 may also be other mechanical fasteners such as a rod with a head and shaft where the shaft has a groove to allow a snap lock ring or other types of securing fasteners. The bolt or screw 28 may be of any type, size, or configuration that is appropriate to secure the panels 22,24 together. The wing nut 30 may also be any other type of nut or engagement member as long as it holds the two panels together with the bolt or screw 28. The second panel 24, which is illustrated as being the lower panel in the figures, has an opening 32 through which the bolt or machine screw 28 passes. The openings 32 may be small enough to engage a shank on the bolt or machine screw 28 to prevent rotation of the bolt or machine screw 28 when the wing nut 30 is secured. If a shank is provided, then bolt or machine screw 28 need not have a slotted head, but could be smooth. Similarly, the first panel 22 preferably has slots 34 for each of the mechanical fasteners to protrude through and engage the wing nut 30 or any other type of nut. This feature of non-rotation of the bolt or machine screw may also be provided by the shape of the shank or a part of the shank that is not round, such as square, and this shape is matched by the shape of the corresponding opening in the panel.

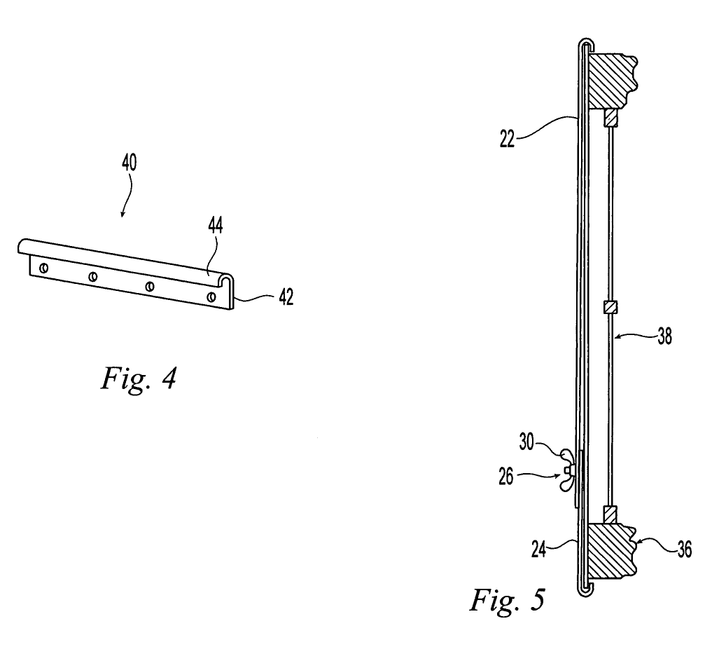

The panels 22,24 are preferably attached to the structure 36 over an opening 38 with an attachment members 40 that are previously secured to the structure 36. The attachment members 40 are best seen in FIG. 4. The attachment members 40 are preferably made from steel or other metal to provide the most security and safety. The attachment members 40 preferably have a flat back portion 42 and a curved portion 44, approximately forming a J-shape. See FIG. 2. The attachment members 40 are secured to the structure 36 with screws or bolts 46 in opposite directions. As can best be seen in FIG. 2, the top attachment member 40 is attached with the curved portion 44 opening in an upward direction (away from the opening in the structure), while the bottom attachment member 40 is attached with the curved portion 44 opening in a downward direction (away from the opening in the structure). The panels 22,24 also have a curved portion 48 along one edge to engage the attachment members 40 as illustrated in FIG. 3. While the panels 22,24 and the attachment members 40 have curved portions to engage one another, the portions may be more square or even in a sharper curved shape, approaching more of a V-shape rather than a J-shape.

The attachment members 40 are preferably mounted well in advance of the need to use the protective covering 20. The attachment members 40 may be painted or otherwise treated to make them appear to be a part of the structure 36.

The panels 22,24 are preferably made of sheet metal that is approximately 1.5 to 2.0 mm thick. The panels 22,24 may also be made of a clear plastic material (i.e., acrylic, polycarbonate) that is thick enough (about 3.0 to 6.5 mm) to comply with the hurricane standards along the coasts, but also allows light to enter the structure. However, thicker or thinner panels may be used.

To mount the panels to the attachment members 40, preferably the first panel 22 is loosely attached to the second panel 24, and the curved portion 48 of first panel 22 is placed into the curved portion 44 of the attachment member 40 attached to the structure 36 adjacent the opening 38. The panels 22,24 are then pushed against the structure 36 and the second panel 24 is pushed upward such that the curved portion 48 engages the curved portion 44 of the attachment member 40. Once the lower panel 24 engages the attachment member 40, the mechanical fasteners 26 is tightened, securing the protective covering 20 to the structure 36.

Alternatively, the first panel 22 could be mounted on (hung on) the attachment member 40 and then the second panel 24 could be loosely attached to the first panel 22, before being pushed up to engage the lower attachment member 40 and secured with the mechanical fasteners.

An alternative way of mounting the protective covering 20 is illustrated in FIG. 5. The protective covering 20 is the same as that illustrated in FIGS. 1-4, but the attachment members 40 are not needed in this embodiment. In this embodiment, the structure has an opening 50 (and a window in this particular illustration) that has a lip 52 to which the curved portions 48 of panels 22,24 are attached. The protective covering is mounted in the same way as described above, with the lip 52 functioning as the attachments members.

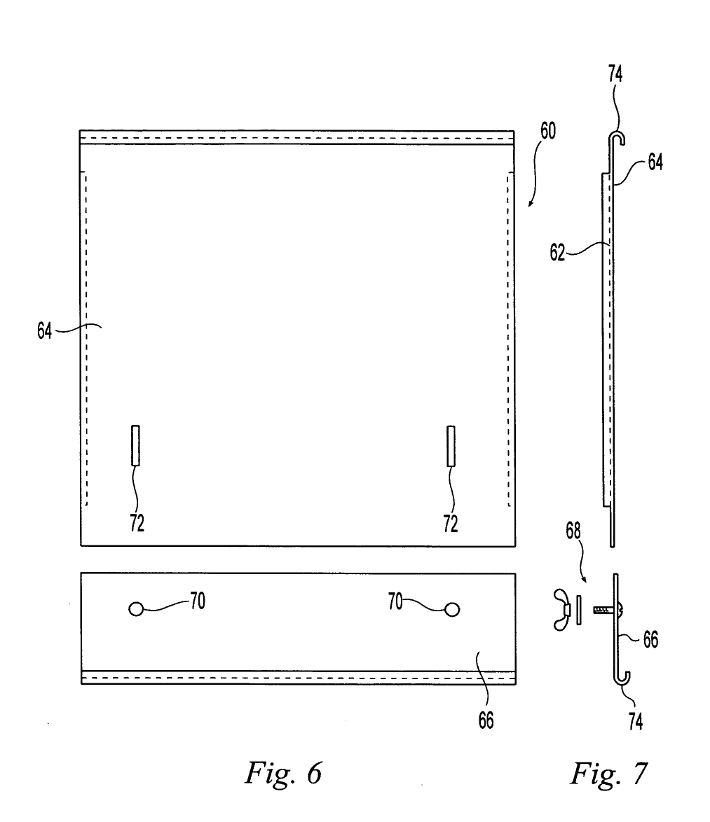

Another alternative embodiment of the protective covering according to the present invention is illustrated in FIGS. 6 & 7. The protective covering 60 is similar to protective covering 20 but has a flange 62 on each side that provides strength and stability to first panel 64. While second panel 66 does not have the flanges 62, the flanges could be added to the second panel 66 as well. The first panel 64 and the second panel 66 are the same as those discussed above, including having mechanical fasteners 68 that pass through holes 70 in the second panel 66 and slots 72 in the first panel to secure them to one another. The first and second panels also have curved portions 74, that are used to attach the panels 64,66 to the structure as in the prior embodiments.

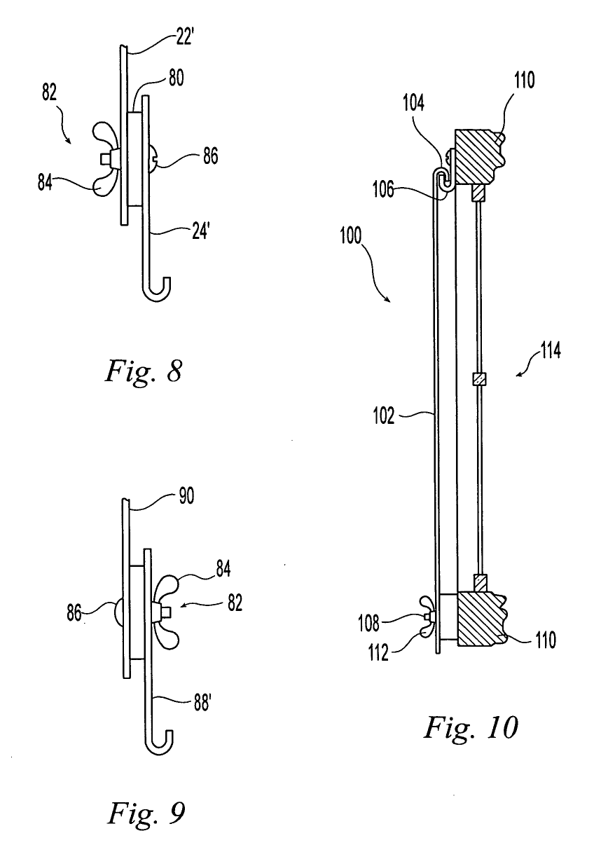

An alternative arrangement for securing the panels of the protective covering is illustrated in FIG. 8. In this embodiment, only a portion of which is shown, the first panel 22′ and second panel 24′ have an energy absorber 80 inserted where the two panels 22′,24′ overlap and are secured to one another by mechanical fastener 82. The energy absorber 80 may any material that reduces noise and shock when the panels 22′,24′ are impacted by flying objects or even the wind. Such materials may include rubber elastomers, foam, cork, and synthetic polymeric materials.

The embodiment illustrated in FIG. 9 is similar to that in FIG. 8, except that the mechanical fastener 82 is turned round, with the wing nut 84 facing the inside of the structure. In this configuration, the protective covering may be installed from the inside of the structure. The panels are carried to the opening and installed as noted above. The final tightening of the mechanical fastener 82 is then done from the inside, preventing someone from the outside from unfastening the fastener 82. Preferably, the screw or bolt 86 has no slots or other configurations to allow a person to gain access. The screw or bolt 86 may also be secured to one of the panels (by welding or any other appropriate manner) to prevent the removal of the bolt or screw. Additionally, while the second panel 88 is illustrated to be on the inside of the first panel 90, it may also be on the outside of the first panel 90.

Another embodiment of a protective covering is illustrated in FIG. 10. In this embodiment, protective covering 100 is a single panel 102 that has a curved portion 104 at the top to cooperate with an attachment member 106, that is similar to the attachment members discussed above. The panel 102 attaches to a screw or bolt 108 attached to the structure 110 with a wing nut 112 or any other appropriate fastener, as discussed above. The protective covering 100 is preferably for smaller openings 114, so that the panel 102 is not too heavy for the owner to lift and put in place.

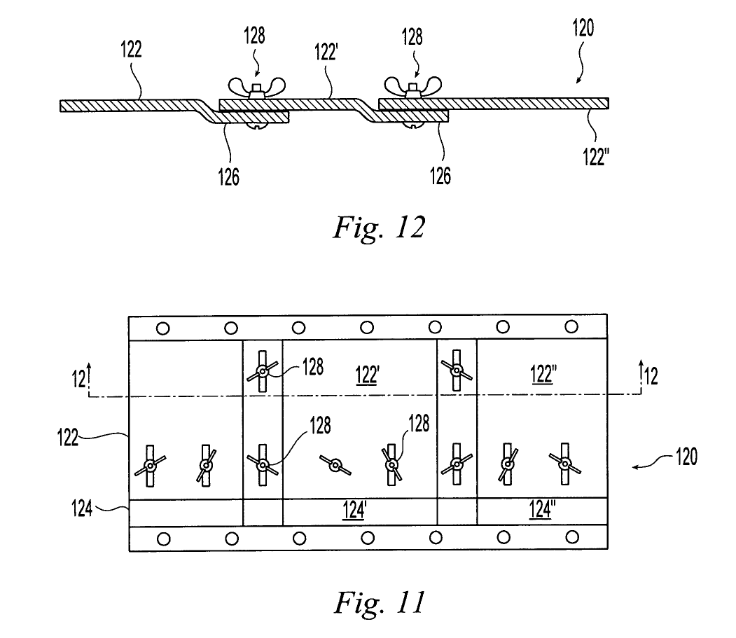

Another embodiment of a protective covering 120 is illustrated in FIGS. 11 and 12. The protective covering 120 has multiple horizontal covering part of an opening in a structure and multiple vertical panels that are linked to those horizontal panels. Protective covering 120 is similar to the other protective coverings in FIGS. 1 and 6 in that they have two panels, a first panel 122 and a second panel 124, that cooperate to cover the opening from the top to the bottom of the structure. However, the protective covering 120 also has panels (122′,122″,124′,124″) that extend across the opening, especially when the opening is relatively large, such as a sliding glass door or a large picture window. Otherwise, each of the panels 122,124 may be too large to handle. As can best be seen in FIG. 12, each of the panels has a portion 126 that is off set to and receives the neighboring panel, for example panel 122 receives panel 122′. Each of the panels has additional holes and slots to allow a fastener 128 to secure the overlapping panels to one another. For example in FIG. 12, a first panel 122 has a fastener 128 to secure it to first panel 122′. Similar fasteners are used to secure each of the second panels to one another (for example panel 124 to panel 124′ and panel 124′ to panel 124″).

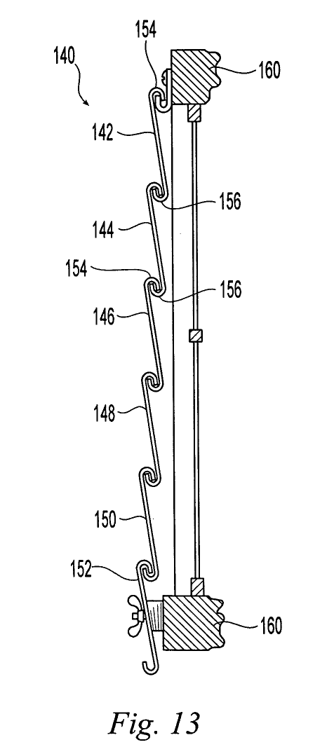

Another embodiment of a protective covering 140 is illustrated in FIG. 13. The protective covering 140 has a plurality of panels 142,144,146,148,150,152 that rest on one another in a vertical direction to cover a larger opening. Each of the panels 142,144,146,148,150,152 may be identical, or the last one, as illustrated in FIG. 13 may be slightly different. That is, the panels each have an S-shape, with a curved portion 154 at the top and 156 at the bottom so that they may attach to one another. However, it is also possible that panel 152 has only one curved portion 154 at the top and a flat portion 158 at the bottom for attachment to the structure 160. While there are six panels shown in FIG. 13, there may be more or fewer panels and they may be wider (top to bottom) or narrower than those illustrated.

It will be apparent to those skilled in the art that various modifications and variations can be made in the protective covering of the present invention without departing from the spirit or scope of the invention. Thus, it is intended that the present invention cover the modifications and variations of this invention provided they come within the scope of the appended claims and their equivalents.

1. A removable, adjustable protective covering for protecting an opening in a structure comprising:
a first panel, the first panel having an upper edge configured to be attached to a portion of the structure adjacent one side of the opening; and
a second panel, the second panel configured to be secured to the first panel and having a lower edge configured to be attached to a portion of the structure adjacent an opposite side of the opening.

2. The removable, adjustable protective covering according to claim 1, further comprising a window mount, the window mount cooperating with an edge of the first and second panels to the secure the panels to the structure.

3. The removable, adjustable protective covering according to claim 2, wherein the first and second panels attach to at least one attachment member mounted to the structure.

4. The removable, adjustable protective covering according to claim 1, further comprising means to releasably secure the first panel to the second panel.

5. The removable, adjustable protective covering according to claim 4, wherein the securing means includes mechanical fasteners.

6. The removable, adjustable protective covering according to claim 1, wherein one of the first and second panels has at least one elongated opening to receive a securing element disposed in the other of the first and second panels.

7. The removable, adjustable protective covering according to claim 1, wherein the first panel is larger in area than the second panel.

8. The removable, adjustable protective covering according to claim 1, further comprising a energy absorbing means disposed between the first and second panels to absorb imparted on at least one of the first and second panels.

9. The removable, adjustable protective covering according to claim 1, wherein the energy absorbing means is one of the group including a rubber elastomers, foam, cork, and synthetic polymeric materials.

10. The removable, adjustable protective covering according to claim 5, wherein the mechanical fasteners are not removable from outside the structure.

11. An adjustable protective covering for protecting an opening in a structure comprising:
a first panel for covering at least a portion of the opening in the structure;
a second panel for covering at least a portion of the opening and configured to be adjustably secured to the first panel, wherein the first and second panels secured to one another having a size that covers at least a portion of the opening in the structure.

12. The adjustable protective covering according to claim 11, further comprising a window mount, the window mount cooperating with an edge of the first and second panels to the secure the panels to the structure.

13. The adjustable protective covering according to claim 11, wherein the first and second panels attach to at least one attachment member mounted to the structure.

14. The adjustable protective covering according to claim 11, further comprising means to releasably secure the first panel to the second panel.

15. The adjustable protective covering according to claim 14, wherein the securing means includes mechanical fasteners.

16. The adjustable protective covering according to claim 11, wherein the first panel has at least one elongated opening to receive a securing element disposed in the second panel.

17. The adjustable protective covering according to claim 11, wherein the first panel is larger in area than the second panel.

18. The adjustable protective covering according to claim 11, further comprising energy absorbing means disposed between the first and second panels to absorb imparted on at least one of the first and second panels.

19. The adjustable protective covering according to claim 18, wherein the energy absorbing means is one of the group including a rubber elastomers, foam, cork, and synthetic polymeric materials.

20. The adjustable protective covering according to claim 15, wherein the mechanical fasteners are not accessible from outside the structure.

21. A removable, adjustable protective covering assembly for protecting an opening in a structure comprising:
a first panel, the first panel having an upper edge configured to be attached to a portion of the structure adjacent one side of the opening;
a plurality of central panels, each of the central panels having a top edge configured to engage a previous panel and a bottom edge configured to engage a next panel; and
a final panel, the final panel configured to be secured to one of the plurality of central panels and having a lower edge configured to be attached to a portion of the structure adjacent an opposite side of the opening; wherein the securing of the final panel to the structure locks the panels to protect the opening in the structure.

22. A removable protective covering for protecting an opening in a structure comprising:
a protective panel sized to cover at least a portion of the opening, the protective panel having an edge configured to be attached to a portion of the structure adjacent a first side of the opening; and
a securing means mounted to at least a second side of the opening to secure the protective panel over the at least a portion of the opening.

23. A removable protective covering according to claim 22, further comprising a first window mount attached to the structure adjacent the opening in the structure to engage the edge of the protective panel.

24. A removable protective covering according to claim 22, wherein the securing means includes a mechanical fastener.

25. A removable protective covering according to claim 22, wherein the second side of the opening is opposite the first side.

26. A method of installing a protective covering for protecting an opening in a structure comprising:
providing a first panel for covering at least a portion of an opening in the structure and a second panel for covering at least a portion of the opening and configured to be adjustably secured to the first panel, the first and second portions covering a majority of the opening;
attaching the first panel to a first side of the opening from inside the structure;
attaching the second panel to a second side of the opening from inside the structure; and
securing the first panel to the second panel from inside the structure with mechanical fasteners such that the fasteners are not easily removable from outside the structure.
